(19) United States
(12) Patent Application Publication
(10) Pub. No.: US 2025/0015632 A1
(43) Pub. Date: Jan. 9, 2025

(54) ENERGY HARVESTING PARAMETERS

(71) Applicant: QUALCOMM Incorporated, San Diego, CA (US)

(72) Inventors: Ahmed Attia ABOTABL, San Diego, CA (US); Ahmed ELSHAFIE, San Diego, CA (US); Alexandros MANOLAKOS, Athens (GR)

(21) Appl. No.: 18/707,108

(22) PCT Filed: Dec. 23, 2022
(86) PCT No.: PCT/US2022/082334

§ 371 Date: May 2, 2024

(30) Foreign Application Priority Data
Jan. 7, 2022 (GR) 20220100008

(51) Int. Cl. H02J 50/00; H02J 50/80

(52) U.S. Cl. CPC H02J 50/001; H02J 50/80

(57) ABSTRACT

Various aspects of the present disclosure generally relate to wireless communication. In some aspects, a first device may generate a request for energy from a second device that is capable of charging the first device in association with energy harvesting. The first device may generate an indication that indicates a maximum duration for which the request applies. The first device may transmit the request and the indication to the second device. Numerous other aspects are described.

### CROSS-REFERENCE TO RELATED APPLICATION

This application claims priority to Greek patent application No. 20220100008, filed on Jan. 7, 2022, entitled “ENERGY HARVESTING PARAMETERS,” which is hereby expressly incorporated by reference herein.

### FIELD OF THE DISCLOSURE

Aspects of the present disclosure generally relate to wireless communication and to techniques and apparatuses for applying parameters to energy harvesting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first device. The method may include generating a request for energy from a second device that is capable of charging the first device in association with energy harvesting. The method may include generating an indication that indicates a maximum duration for which the request applies. The method may include transmitting the request and the indication to the second device.

Some aspects described herein relate to a method of wireless communication performed by a second device. The method may include receiving, from a first device, a request for energy from the second device and an indication that indicates a maximum duration for which the request applies. The method may include charging, in association with energy harvesting, the first device within the maximum duration based at least in part on a charging rule. The method may include refraining from charging the first device after the maximum duration.

Some aspects described herein relate to a method of wireless communication performed by a first device. The method may include generating historical information that is associated with a timing for the first device between requesting and receiving energy in association with energy harvesting. The method may include generating a request for energy from a second device that is capable of charging the first device in association with energy harvesting. The method may include transmitting, to the second device, the request and the historical information.

Some aspects described herein relate to a method of wireless communication performed by a second device. The method may include receiving, from a first device, a request for energy from the second device. The method may include performing one of charging the first device, refraining from charging the first device, or charging a third device based at least in part on historical information that is associated with a timing for the first device between requesting and receiving energy.

Some aspects described herein relate to a first device for wireless communication. The first device may include a memory and one or more processors coupled to the memory. The one or more processors may be configured to generate a request for energy from a second device that is capable of charging the first device in association with energy harvesting. The one or more processors may be configured to generate an indication that indicates a maximum duration for which the request applies. The one or more processors may be configured to transmit the request and the indication to the second device.

Some aspects described herein relate to a second device for wireless communication. The second device may include a memory and one or more processors coupled to the memory. The one or more processors may be configured to receive, from a first device, a request for energy from the second device and an indication that indicates a maximum duration for which the request applies. The one or more processors may be configured to charge, in association with energy harvesting, the first device within the maximum duration based at least in part on a charging rule. The one or more processors may be configured to refrain from charging the first device after the maximum duration.

Some aspects described herein relate to a first device for wireless communication. The first device may include a memory and one or more processors coupled to the memory. The one or more processors may be configured to generate historical information that is associated with a timing for the first device between requesting and receiving energy in association with energy harvesting. The one or more processors may be configured to generate a request for energy from a second device that is capable of charging the first device in association with energy harvesting. The one or more processors may be configured to transmit, to the second device, the request and the historical information.

Some aspects described herein relate to a second device for wireless communication. The second device may include a memory and one or more processors coupled to the memory. The one or more processors may be configured to receive, from a first device, a request for energy from the second device. The one or more processors may be configured to perform one of charging the first device, refraining from charging the first device, or charging a third device based at least in part on historical information that is associated with a timing for the first device between requesting and receiving energy.

Some aspects described herein relate to a non-transitory computer-readable medium that stores a set of instructions for wireless communication by a first device. The set of instructions, when executed by one or more processors of the first device, may cause the first device to generate a request for energy from a second device that is capable of charging the first device in association with energy harvesting. The set of instructions, when executed by one or more processors of the first device, may cause the first device to generate an indication that indicates a maximum duration for which the request applies. The set of instructions, when executed by one or more processors of the first device, may cause the first device to transmit the request and the indication to the second device.

Some aspects described herein relate to a non-transitory computer-readable medium that stores a set of instructions for wireless communication by a second device. The set of instructions, when executed by one or more processors of the second device, may cause the second device to receive, from a first device, a request for energy from the second device and an indication that indicates a maximum duration for which the request applies. The set of instructions, when executed by one or more processors of the second device, may cause the second device to charge, in association with energy harvesting, the first device within the maximum duration based at least in part on a charging rule. The set of instructions, when executed by one or more processors of the second device, may cause the second device to refrain from charging the first device after the maximum duration.

Some aspects described herein relate to a non-transitory computer-readable medium that stores a set of instructions for wireless communication by a first device. The set of instructions, when executed by one or more processors of the first device, may cause the first device to generate historical information that is associated with a timing for the first device between requesting and receiving energy in association with energy harvesting. The set of instructions, when executed by one or more processors of the first device, may cause the first device to generate a request for energy from a second device that is capable of charging the first device in association with energy harvesting. The set of instructions, when executed by one or more processors of the first device, may cause the first device to transmit, to the second device, the request and the historical information.

Some aspects described herein relate to a non-transitory computer-readable medium that stores a set of instructions for wireless communication by a second device. The set of instructions, when executed by one or more processors of the second device, may cause the second device to receive, from a first device, a request for energy from the second device. The set of instructions, when executed by one or more processors of the second device, may cause the second device to perform one of charging the first device, refraining from charging the first device, or charging a third device based at least in part on historical information that is associated with a timing for the first device between requesting and receiving energy.

Some aspects described herein relate to an apparatus for wireless communication. The apparatus may include means for generating a request for energy from another apparatus that is capable of charging the apparatus in association with energy harvesting. The apparatus may include means for generating an indication that indicates a maximum duration for which the request applies. The apparatus may include means for transmitting the request and the indication to the other apparatus.

Some aspects described herein relate to an apparatus for wireless communication. The apparatus may include means for receiving, from another apparatus, a request for energy from the apparatus and an indication that indicates a maximum duration for which the request applies. The apparatus may include means for charging, in association with energy harvesting, the other apparatus within the maximum duration based at least in part on a charging rule. The apparatus may include means for refraining from charging the other apparatus after the maximum duration.

Some aspects described herein relate to an apparatus for wireless communication. The apparatus may include means for generating historical information that is associated with a timing for the apparatus between requesting and receiving energy in association with energy harvesting. The apparatus may include means for generating a request for energy from another apparatus that is capable of charging the apparatus in association with energy harvesting. The apparatus may include means for transmitting, to the other apparatus, the request and the historical information.

Some aspects described herein relate to a first apparatus for wireless communication. The first apparatus may include means for receiving, from a second apparatus, a request for energy from the first apparatus and means for performing one of charging the second apparatus, refraining from charging the second apparatus, or charging a third apparatus based at least in part on historical information that is associated with a timing for the second apparatus between requesting and receiving energy.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of energy harvesting, in accordance with the present disclosure.

FIG. 4 is a diagram illustrating an example associated with indicating a maximum duration for a request for energy, in accordance with the present disclosure.

FIG. 5 is a diagram illustrating an example associated with providing energy upon request, in accordance with the present disclosure.

FIG. 6 is a diagram illustrating an example process performed, for example, by a first device, in accordance with the present disclosure.

FIG. 7 is a diagram illustrating an example process performed, for example, by a second device, in accordance with the present disclosure.

FIG. 8 is a diagram illustrating an example process performed, for example, by a first device, in accordance with the present disclosure.

FIG. 9 is a diagram illustrating an example process performed, for example, by a second device, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

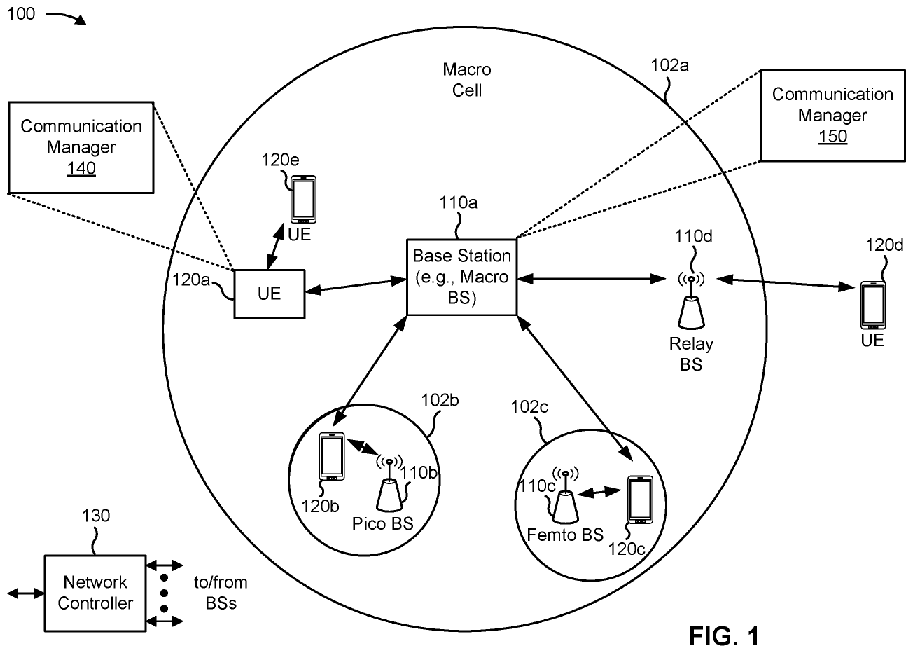

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120c), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrow band IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the first device (e.g., a UE 120) may include a communication manager 140. As described in more detail elsewhere herein, the communication manager 140 may generate a request for energy from a second device that is capable of charging the first device in association with energy harvesting. In association with energy harvesting may mean that the first device may harvest energy (e.g., radio frequency (RF) energy, vibration energy) provided towards the first device by the second device. In association with energy harvesting may also mean that the second device may use energy harvesting to obtain energy to provide to the first device. The communication manager 140 may generate an indication that indicates a maximum duration for which the request applies and transmit the request and the indication to the second device.

In some aspects, the second device (e.g., a UE 120, base station 110) may include a communication manager 140 or 150. As described in more detail elsewhere herein, the communication manager 140 or 150 may receive, from a first device, a request for energy from the second device and an indication that indicates a maximum duration for which the request applies. The communication manager 140 or 150 may charge, in association with energy harvesting, the first device within the maximum duration based at least in part on a charging rule and refrain from charging the first device after the maximum duration. Additionally, or alternatively, the communication manager 140 or 150 may perform one or more other operations described herein.

In some aspects, the communication manager 140 may generate historical information that is associated with a timing for the first device between requesting and receiving energy in association with energy harvesting and generate a request for energy from a second device that is capable of charging the first device in association with energy harvesting. The communication manager 140 may transmit, to the second device, the request and the historical information. Additionally, or alternatively, the communication manager 140 may perform one or more other operations described herein.

In some aspects, the communication manager 140 or 150 may receive, from a first device, a request for energy from the second device and perform one of charging the first device, refraining from charging the first device, or charging a third device based at least in part on historical information that is associated with a timing for the first device between requesting and receiving energy. Additionally, or alternatively, the communication manager 140 or 150 may perform one or more other operations described herein.

As indicated above, FIG. 1 is provided as an example. Other examples may differ from what is described with regard to FIG. 1.

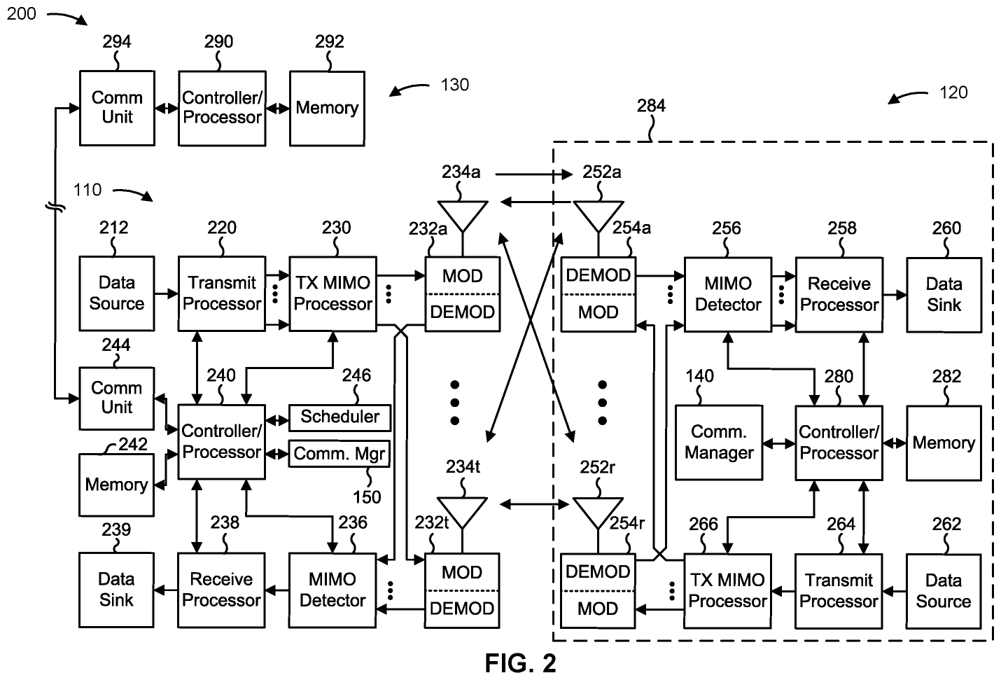

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

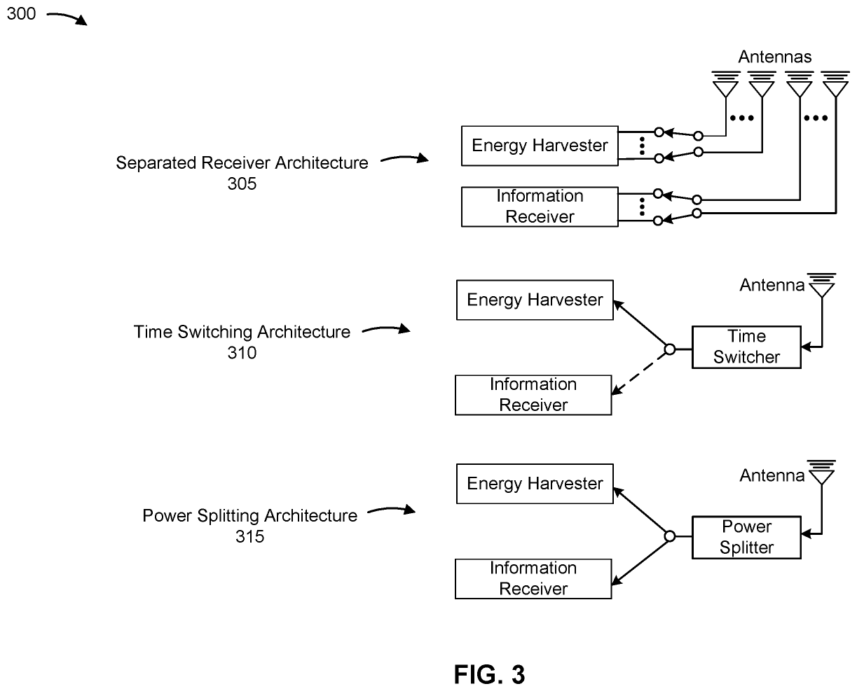

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-11).

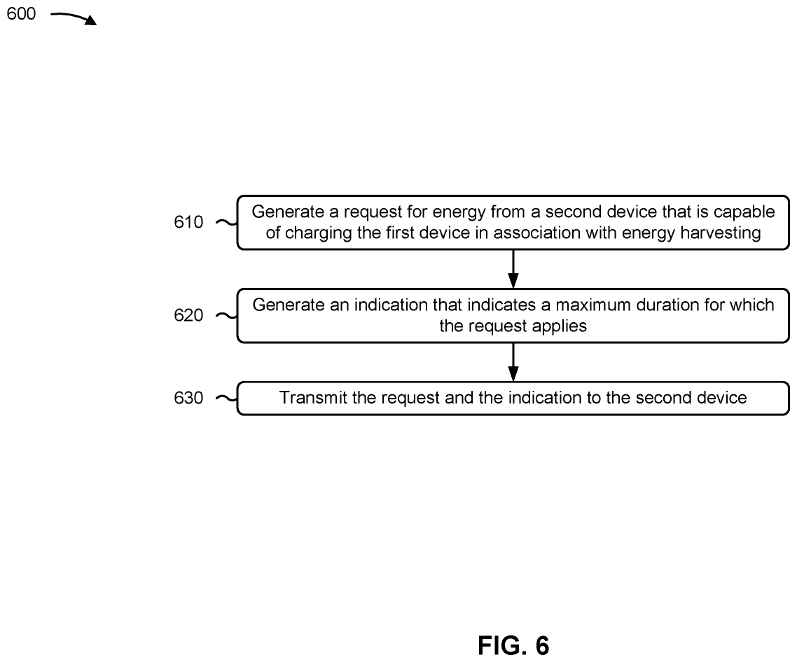

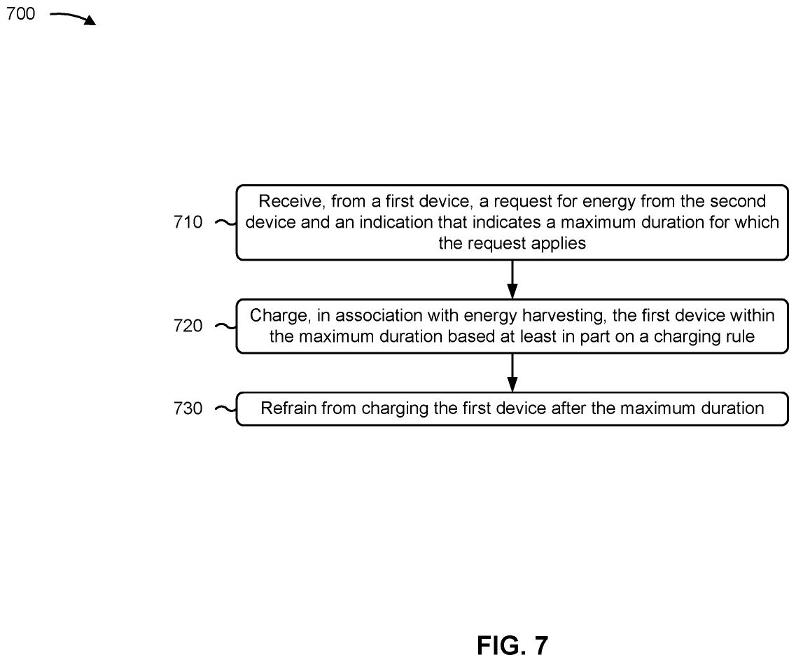

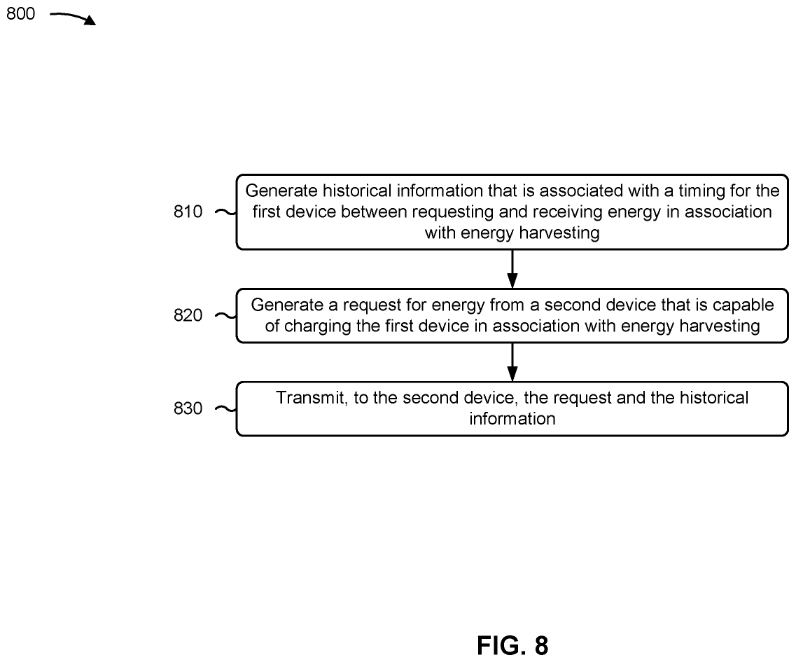

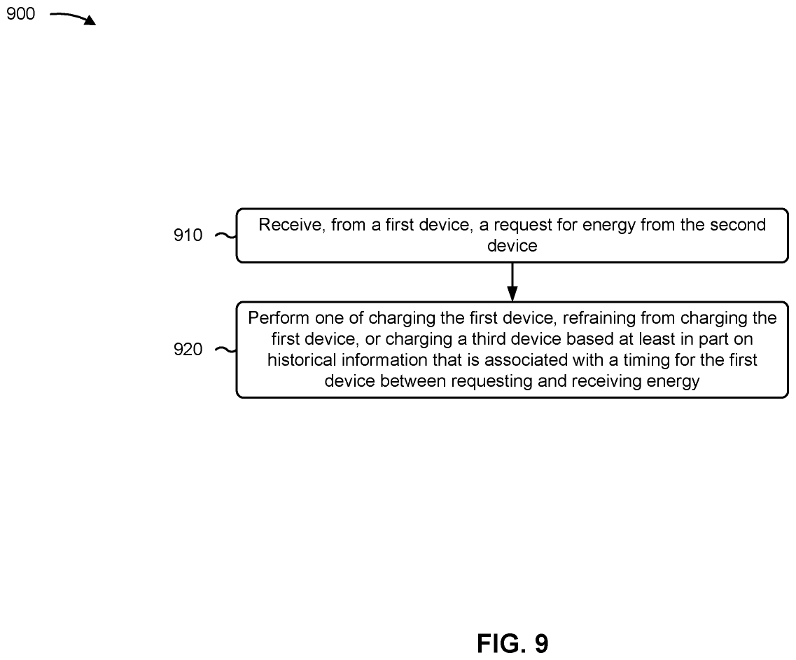

The controller/processor 240 of the base station 110, the controller/processor 280 of the UE 120, and/or any other component(s) of FIG. 2 may perform one or more techniques associated with using parameters for energy harvesting, as described in more detail elsewhere herein. In some aspects, the first device described herein is the UE 120, is included in the UE 120, or includes one or more components of the UE 120 shown in FIG. 2. In some aspects, the second device described herein is the UE 120, is included in the UE 120, includes one or more components of the UE 120, is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a first device (e.g., a UE 120) includes means for generating a request for energy from a second device that is capable of charging the first device in association with energy harvesting: means for generating an indication that indicates a maximum duration for which the request applies; and/or means for transmitting the request and the indication to the second device. In some aspects, the means for the first device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a second device (e.g., a UE 120, base station 110) includes means for receiving, from a first device, a request for energy from the second device and an indication that indicates a maximum duration for which the request applies: means for charging, in association with energy harvesting, the first device within the maximum duration based at least in part on a charging rule; and/or means for refraining from charging the first device after the maximum duration. In some aspects, the means for the second device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the second device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the first device includes means for generating historical information that is associated with a timing for the first device between requesting and receiving energy in association with energy harvesting: means for generating a request for energy from a second device that is capable of charging the first device in association with energy harvesting; and/or means for transmitting, to the second device, the request and the historical information.

In some aspects, the second device includes means for receiving, from a first device, a request for energy from the second device; and/or means for performing one of charging the first device, refraining from charging the first device, or charging a third device based at least in part on historical information that is associated with a timing for the first device between requesting and receiving energy.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of energy harvesting, in accordance with the present disclosure.

Energy harvesting includes obtaining energy from a source besides an on-device battery. Devices that use energy harvesting may have a small battery (e.g., smart watch) or no battery (e.g., zero power devices, IoT devices, wearables, or financial devices). Energy harvesting may include converting RF energy transferred from another device. The harvesting of RF energy may not necessarily fully charge a battery but may be used for some tasks like data decoding, operating some filters, data reception, data encoding, data reception, and/or data transmission. The energy may be accumulated over time. Energy harvesting may also be a part of self-sustainable networks, where a node in the network can interact in the network through the energy harvested in the network through transmissions.

As shown in FIG. 3, an RF receiver (e.g., a UE 120) may receive signals (e.g., radio signals carried on radio waves) from an RF transmitter (e.g., a base station 110 or UE 120) and convert electromagnetic energy of the signals (e.g., using a rectenna comprising a dipole antenna with an RF diode) into direct current electricity for use by the RF receiver. The RF receiver may be a low power device or a zero power device. The RF transmitter may be referred to as a “charging device”.

As shown by reference number 305, in some aspects, the RF receiver may use a separated receiver architecture, where a first set of antennas is configured to harvest energy, and a second set of antennas is configured to receive data. In this scenario, each set of antennas may be separately configured to receive signals at certain times, frequencies, and/or via one or more particular beams, such that all signals received by the first set of antennas are harvested for energy, and all signals received by the second set of antennas are processed to receive information.

As shown by reference number 310, in some aspects, the RF receiver may use a time-switching architecture to harvest energy. The time switching architecture may use one or more antennas to receive signals, and whether the signals are harvested for energy or processed to receive information depends on the time at which the signals are received. For example, one or more first time slots may be time slots during which received signals are sent to one or more energy harvesting components to harvest energy, and one or more second time slots may be time slots during which received signals are processed and decoded to receive information. In some aspects, the time slots may be pre-configured (e.g., by the RF receiver, the RF transmitter, or another device).

As shown by reference number 315, in some aspects, the RF receiver may use a power splitting architecture to harvest energy. The power splitting architecture may use one or more antennas to receive signals, and the signals are handled by one or both of the energy harvesting and/or information receiving components according to an energy harvesting rate. For example, the RF receiver may be configured to use a first portion of received signals for energy harvesting and the remaining received signals for information receiving. In some aspects, the energy harvesting rate may be pre-configured (e.g., by the RF receiver, the RF transmitter, or another device).

The RF receiver may receive signals for energy harvesting on certain resources (e.g., time, frequency, and/or spatial resources) and at a certain power level that results in a particular charging rate. Energy harvested by the RF receiver may be used and/or stored for later use. For example, in some aspects, the RF receiver may be powered directly by the harvested energy. In some aspects, the RF receiver may use an energy storage device, such as a battery, capacitor, and/or supercapacitor, to gather and store harvested energy for immediate and/or later use.

Energy harvesting devices, more generally, may rely equally or differently on different energy harvesting techniques such as solar power, vibration, or RF energy harvesting. Energy harvesting other than via RF energy can be predictable, and if the RF transmitter requests energy, the RF transmitter may have information that there is a high probability that other sources of energy may be available at a later time. Therefore, if RF charging is delayed, the request for energy can become useless and waste energy. This may be an issue if the charging device is another UE.

As indicated above, FIG. 3 is provided as an example. Other examples may differ from what is described with regard to FIG. 3.

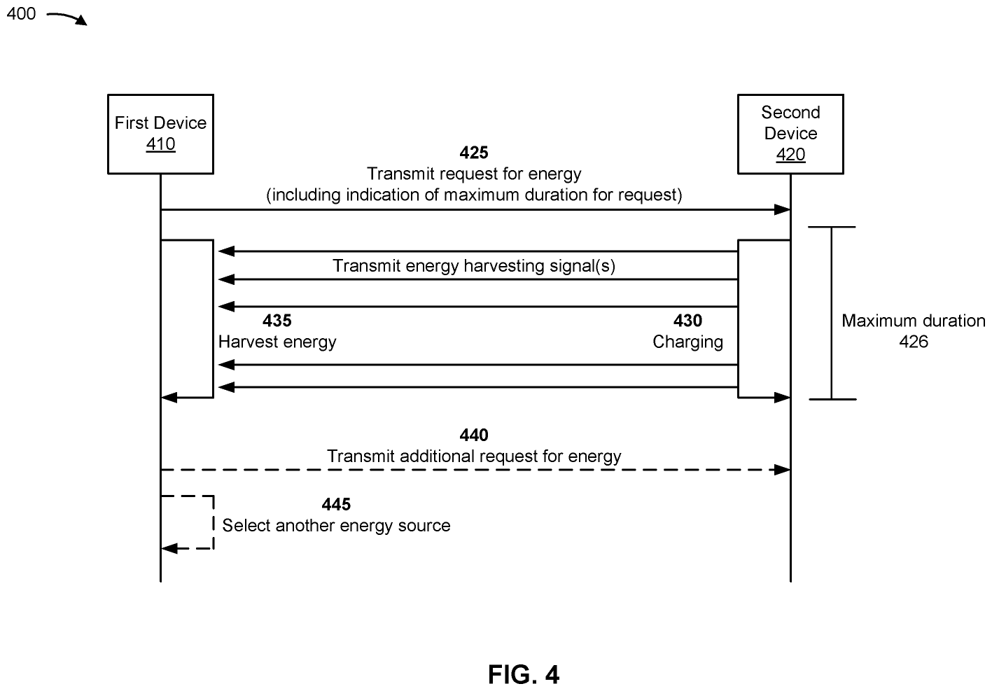

FIG. 4 is a diagram illustrating an example 400 associated with indicating a maximum duration for a request for energy, in accordance with the present disclosure. As shown in FIG. 4, a first device 410 (e.g., IoT, zero power device, a UE 120) may harvest energy from a second (charging) device 420 (e.g., base station 110, UE 120).

According to various aspects described herein, a first device (e.g., RF receiver) may indicate a maximum duration for which a request for energy applies. A second device (e.g., RF transmitter, charging UE) may charge the first device within the maximum duration and refrain from charging the first device after the maximum duration. The maximum duration may be dynamic such that the maximum duration may change for each request. A request may indicate the maximum duration, or the maximum duration may be indicated separately (e.g., in a medium access control control element (MAC CE), in a radio resource control (RRC) message, at RRC configuration). An indication of the maximum duration may also be provided in UE assistance information.

As shown by reference number 425, the first device 410 may transmit a request for energy. The request may include an indication of a maximum duration 426 for which the request applies. As shown by reference number 430, the second device 420 may begin charging the first device 410 within the maximum duration 426. The second device may transmit energy harvesting signals to the energy harvesting device. As shown by reference number 435, the first device 410 may harvest the energy.

The second device 420 may charge the first device 410 based at least in part on a charging rule. For example, if a condition for the first device 410 meets a criterion for charging (e.g., energy level of first device 410 meets a minimum energy level threshold), then charging may take place. If the condition does not meet the criterion, then charging will not take place. In some aspects, the second device 420 may adjust the energy harvesting reception and/or transmission process by activating or canceling energy harvesting reception, increasing a charging rate, or decreasing a charging rate. If charging occurs, the charging may stop by the end of the maximum duration 426.

In some aspects, if the first device 410 does not receive any energy during the maximum duration 426, the first device 410 may determine that the request for energy is denied. The first device 410 may then transmit an additional request for energy, as shown by reference number 440, or select another energy source, as shown by reference number 445. By indicating a maximum duration for a request for energy, the first device 410 may help the second device 420 to conserve energy.

As indicated above, FIG. 4 is provided as an example. Other examples may differ from what is described with respect to FIG. 4.

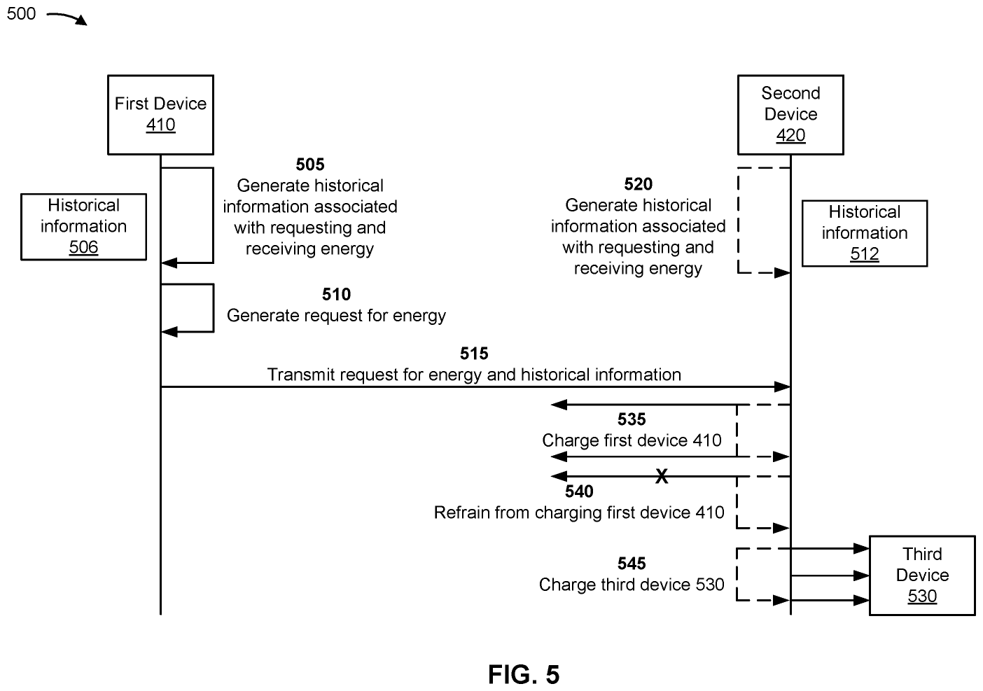

FIG. 5 is a diagram illustrating an example 500 associated with providing energy upon request, in accordance with the present disclosure.

In some aspects, a charging device may use historical information provided by devices or generating by the charging device to determine when and where to provide energy. As shown by reference number 505, the first device 410 may generate historical information 506 that is associated with a timing for the first device 410 between requesting and receiving energy in association with energy harvesting. The timing may involve one or more parameters. For example, the timing may include an average duration between when the first device 410 requests energy and when the first device 410 receives energy (e.g., starts to receive energy). The first device 410 may calculate the average duration based at least in part on a specified quantity of the most recent requests, such as from the last 2 requests, the last 10 requests, the last 100 requests, and so forth. The historical information 506 may include how much energy was transferred via energy harvesting and/or how long the energy harvesting lasted for each session (or an average duration of the sessions). The historical information 506 may include a longest duration, a shortest duration, and/or a median duration between requesting and receiving energy. The historical information 506 may include a most recent time when the first device 410 received energy upon request. As shown by reference number 510, the first device 410 may also generate a request for energy. As shown by reference number 515, the first device 410 may transmit the request for energy and the historical information 506. The historical information 506 may be included with the request or separately from the request.

As shown by reference number 520, the second device 420 may also generate historical information 512 for one or more devices, including a timing between requesting and receiving energy. The historical information 512 may include at least the same parameters described for historical information 506. The historical information 512 may include not only historical information for the first device 410 but historical information for other devices, such as for a third device 530.

The second device 420 may determine whether to provide energy to the first device 410 based at least in part on a charging rule. The rule may specify that the second device 420 is to provide energy upon request. As shown by reference number 535, the second device 420 may charge the first device 410. The second device 420 may charge the first device 410 up to a maximum duration. If the second device 420 is, for example, a UE, the rule may specify that the second device 420 is to provide energy to the first device 410 if the energy level of the second device 420 satisfies an energy threshold (e.g., minimum energy level) or if a parameter in the historical information 506 and/or the historical information 512 satisfies a historical parameter threshold (e.g., minimum duration since last charging). As shown by reference number 540, the second device 420 may refrain from charging the first device 410 based at least in part on one or more charging rules (e.g., charge only if energy level threshold and/or historical parameter threshold satisfied).

In some aspects, the second device 420 may consider the request from the first device 410 in light of other requests for energy, including a request for energy from the third device 530. The rule may specify that the second device 420 is to consider the historical information 506 from the first device 410 and/or the historical information 512 for multiple devices. Note that the first device 410 may have been charged by devices other than the second device 420 or the second device 420 may not store detailed information for each device for a long period of time and thus the historical information 506 for the first device 410 may be beneficial to the second device 420. The rule may be a fairness rule so as to provide energy to devices that have waited longer or that indicate a lower energy level. For example, the second device 420 may charge the first device 410 if the average duration for the first device 410 between requesting and receiving energy is greater than the average duration for the third device 530. However, if the average duration for the first device 410 is less than the average duration for the third device 530, the second device 420 may charge the third device 530, as shown by reference number 545. The second device 420 may help to reduce the average time for each device that can be charged by the second device 420. The second device 420 may also decide to charge a device with a longest time since a most recent charging or based at least in part on other parameters associated with energy harvesting. By using historical information for energy harvesting requests, the second device 420 may more efficiently handle charging for one or more devices.

As indicated above, FIG. 5 is provided as an example. Other examples may differ from what is described with regard to FIG. 5.

FIG. 6 is a diagram illustrating an example process 600 performed, for example, by a first device, in accordance with the present disclosure. Example process 600 is an example where the first device (e.g., a UE 120, first device 410) performs operations associated with indicating a maximum duration for energy harvesting.

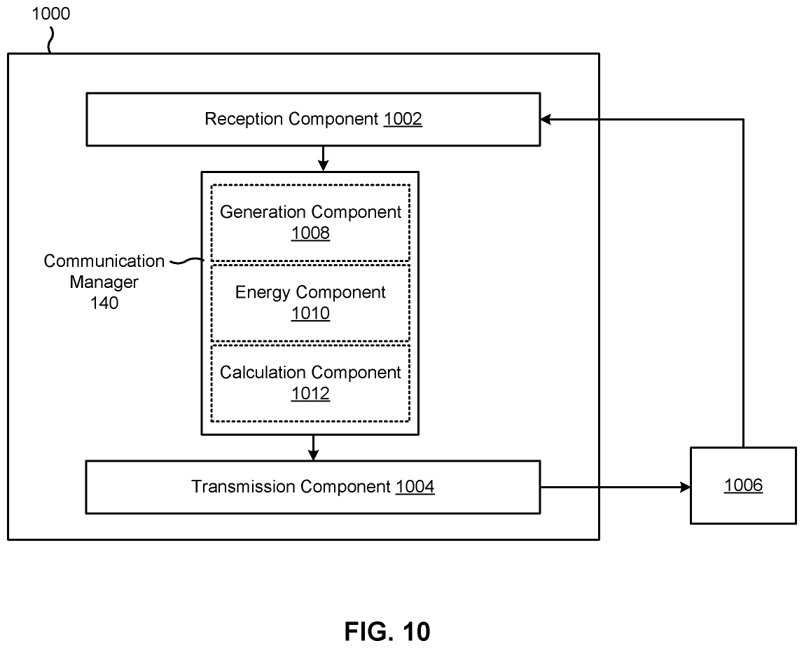

As shown in FIG. 6, in some aspects, process 600 may include generating a request for energy from a second device that is capable of charging the first device in association with energy harvesting (block 610). For example, the first device (e.g., using communication manager 140 and/or generation component 1008 depicted in FIG. 10) may generate a request for energy from a second device that is capable of charging the first device in association with energy harvesting, as described above.

As further shown in FIG. 6, in some aspects, process 600 may include generating an indication that indicates a maximum duration for which the request applies (block 620). For example, the first device (e.g., using communication manager 140 and/or generation component 1008 depicted in FIG. 10) may generate an indication that indicates a maximum duration for which the request applies, as described above.

As further shown in FIG. 6, in some aspects, process 600 may include transmitting the request and the indication to the second device (block 630). For example, the first device (e.g., using communication manager 140 and/or transmission component 1004 depicted in FIG. 10) may transmit the request and the indication to the second device, as described above.

Process 600 may include additional aspects, such as any single aspect or any combination of aspects described below and/or in connection with one or more other processes described elsewhere herein.

In a first aspect, transmitting the indication includes transmitting the indication in assistance information.

In a second aspect, alone or in combination with the first aspect, process 600 includes transmitting another request for energy to the second device or selecting another energy source.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a second device, in accordance with the present disclosure. Example process 700 is an example where the second device (e.g., a UE 120, base station 110, second device 420) performs operations associated with using a maximum duration for an energy harvesting request.

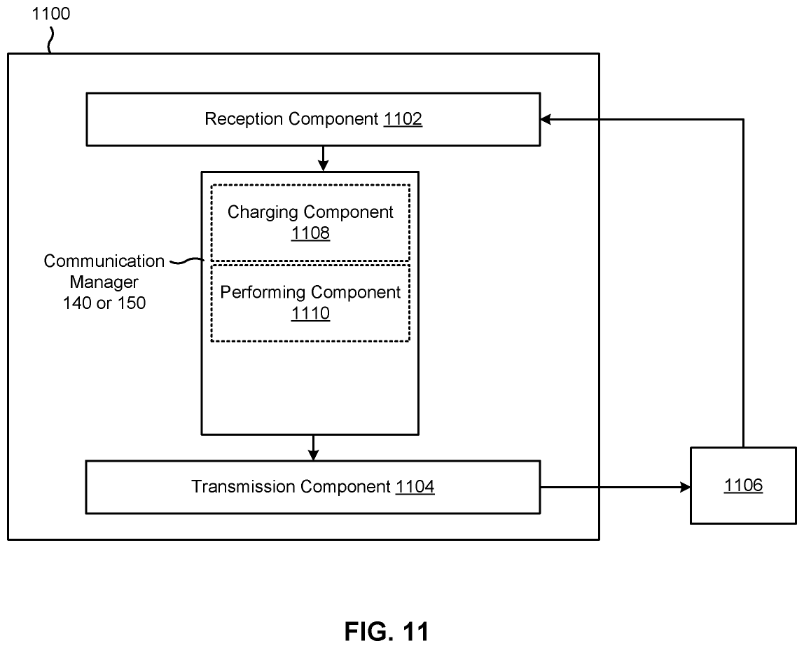

As shown in FIG. 7, in some aspects, process 700 may include receiving, from a first device, a request for energy from the second device and an indication that indicates a maximum duration for which the request applies (block 710). For example, the second device (e.g., using communication manager 140 or 150 and/or reception component 1102 depicted in FIG. 11) may receive, from a first device, a request for energy from the second device and an indication that indicates a maximum duration for which the request applies, as described above.

As further shown in FIG. 7, in some aspects, process 700 may include charging, in association with energy harvesting, the first device within the maximum duration based at least in part on a charging rule (block 720). For example, the second device (e.g., using communication manager 140 or 150 and/or charging component 1108 depicted in FIG. 11) may charge, in association with energy harvesting, the first device within the maximum duration based at least in part on a charging rule, as described above.

As further shown in FIG. 7, in some aspects, process 700 may include refraining from charging the first device after the maximum duration (block 730). For example, the second device (e.g., using communication manager 140 or 150 and/or charging component 1108 depicted in FIG. 11) may refrain from charging the first device after the maximum duration, as described above.

Process 700 may include additional aspects, such as any single aspect or any combination of aspects described below and/or in connection with one or more other processes described elsewhere herein.

In a first aspect, process 700 includes receiving, from the first device, another request for energy after the maximum duration, and charging the second device based at least in part on the charging rule.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a first device, in accordance with the present disclosure. Example process 800 is an example where the first device (e.g., a UE 120, first device 410) performs operations associated with indicating historical information associated with energy harvesting.

As shown in FIG. 8, in some aspects, process 800 may include generating historical information that is associated with a timing for the first device between requesting and receiving energy in association with energy harvesting (block 810). For example, the first device (e.g., using communication manager 140 and/or generation component 1008 depicted in FIG. 10) may generate historical information that is associated with a timing for the first device between requesting and receiving energy in association with energy harvesting, as described above.

As further shown in FIG. 8, in some aspects, process 800 may include generating a request for energy from a second device that is capable of charging the first device in association with energy harvesting (block 820). For example, the first device (e.g., using communication manager 140 and/or generation component 1008 depicted in FIG. 10) may generate a request for energy from a second device that is capable of charging the first device in association with energy harvesting, as described above.

As further shown in FIG. 8, in some aspects, process 800 may include transmitting, to the second device, the request and the historical information (block 830). For example, the first device (e.g., using communication manager 140 and/or transmission component 1004 depicted in FIG. 10) may transmit, to the second device, the request and the historical information, as described above.

Process 800 may include additional aspects, such as any single aspect or any combination of aspects described below and/or in connection with one or more other processes described elsewhere herein.

In a first aspect, the historical information includes an average duration for the first device between requesting and receiving energy.

In a second aspect, alone or in combination with the first aspect, process 800 includes calculating the average duration for the first device based at least in part on a specified quantity of most recent requests.

In a third aspect, alone or in combination with one or more of the first and second aspects, the historical information includes a longest duration for the first device between requesting and receiving energy.

In a fourth aspect, alone or in combination with one or more of the first through third aspects, the historical information includes a most recent time when the first device received energy upon request.

In a fifth aspect, alone or in combination with one or more of the first through fourth aspects, the historical information includes a median duration for the first device between requesting and receiving energy.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a second device, in accordance with the present disclosure. Example process 900 is an example where the second device (e.g., a UE 120, base station 110, second device 420) performs operations associated with using historical information associated with energy harvesting.

As shown in FIG. 9, in some aspects, process 900 may include receiving, from a first device, a request for energy from the second device (block 910). For example, the second device (e.g., using communication manager 140 or 150 and/or reception component 1102 depicted in FIG. 11) may receive, from a first device, a request for energy from the second device, as described above.

As further shown in FIG. 9, in some aspects, process 900 may include performing one of charging the first device, refraining from charging the first device, or charging a third device based at least in part on historical information that is associated with a timing for the first device between requesting and receiving energy (block 920). For example, the second device (e.g., using communication manager 140 or 150 and/or performing component 1110 depicted in FIG. 11) may perform one of charging the first device, refraining from charging the first device, or charging a third device based at least in part on historical information that is associated with a timing for the first device between requesting and receiving energy, as described above.

Process 900 may include additional aspects, such as any single aspect or any combination of aspects described below and/or in connection with one or more other processes described elsewhere herein.

In a first aspect, process 900 includes receiving the historical information from the first device.

In a second aspect, alone or in combination with the first aspect, the historical information includes an average duration for the first device between requesting and receiving energy.

In a third aspect, alone or in combination with one or more of the first and second aspects, the performing includes charging the first device if the average duration for the first device is greater than an average duration for the third device, or charging the third device if the average duration for the third device is greater than the average duration for the first device.

In a fourth aspect, alone or in combination with one or more of the first through third aspects, the historical information includes a longest duration for the first device between requesting and receiving energy.

In a fifth aspect, alone or in combination with one or more of the first through fourth aspects, the historical information includes a most recent time when the first device received energy upon request.

In a sixth aspect, alone or in combination with one or more of the first through fifth aspects, the historical information includes a median duration for the first device between requesting and receiving energy.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a first device (e.g., a UE 120, first device 410), or a first device may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a generation component 1008, an energy component 1010, and/or a calculation component 1012, among other examples.

In some aspects, the apparatus 1000 may be configured to perform one or more operations described herein in connection with FIGS. 1-5. Additionally, or alternatively, the apparatus 1000 may be configured to perform one or more processes described herein, such as process 600 of FIG. 6, process 800 of FIG. 8, or a combination thereof. In some aspects, the apparatus 1000 and/or one or more components shown in FIG. 10 may include one or more components of the first device described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the first device described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the first device described in connection with FIG. 2. In some aspects, the transmission component 1004 may be co-located with the reception component 1002 in a transceiver.

The generation component 1008 may generate a request for energy from a second device that is capable of charging the first device in association with energy harvesting. The generation component 1008 may generate an indication that indicates a maximum duration for which the request applies. The transmission component 1004 may transmit the request and the indication to the second device. The transmission component 1004 may transmit another request for energy to the second device. The energy component 1010 may select another energy source.

In some aspects, the generation component 1008 may generate historical information that is associated with a timing for the first device between requesting and receiving energy in association with energy harvesting. The generation component 1008 may generate a request for energy from a second device that is capable of charging the first device in association with energy harvesting. The transmission component 1004 may transmit, to the second device, the request and the historical information. The calculation component 1012 may calculate the average duration for the first device based at least in part on a specified quantity of most recent requests.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a second device (e.g., a UE 120, base station 110, second device 420), or a second device may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140 or 150. The communication manager 140 or 150 may include a charging component 1108 and/or a performing component 1110, among other examples.

In some aspects, the apparatus 1100 may be configured to perform one or more operations described herein in connection with FIGS. 1-5. Additionally, or alternatively, the apparatus 1100 may be configured to perform one or more processes described herein, such as process 700 of FIG. 7, process 900 of FIG. 9, or a combination thereof. In some aspects, the apparatus 1100 and/or one or more components shown in FIG. 11 may include one or more components of the second device described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the second device described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the second device described in connection with FIG. 2. In some aspects, the transmission component 1104 may be co-located with the reception component 1102 in a transceiver.

The reception component 1102 may receive, from a first device, a request for energy from the second device and an indication that indicates a maximum duration for which the request applies. The charging component 1108 may charge, in association with energy harvesting, the first device within the maximum duration based at least in part on a charging rule. The charging component 1108 may refrain from charging the first device after the maximum duration.

The reception component 1102 may receive, from the first device, another request for energy after the maximum duration. The charging component 1108 may charge the second device based at least in part on the charging rule.

The reception component 1102 may receive, from a first device, a request for energy from the second device. The reception component 1102 may receive historical information from the first device. The performing component 1110 may perform one of charging the first device, refraining from charging the first device, or charging a third device based at least in part on the historical information that is associated with a timing for the first device between requesting and receiving energy.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a first device, comprising: generating a request for energy from a second device that is capable of charging the first device in association with energy harvesting: generating an indication that indicates a maximum duration for which the request applies; and transmitting the request and the indication to the second device.

Aspect 2: The method of Aspect 1, wherein transmitting the indication includes transmitting the indication in assistance information.

Aspect 3: The method of Aspect 1 or 2, further comprising, if energy is not received during the maximum duration: transmitting another request for energy to the second device: or selecting another energy source.

Aspect 4: A method of wireless communication performed by a second device, comprising: receiving, from a first device, a request for energy from the second device and an indication that indicates a maximum duration for which the request applies: charging, in association with energy harvesting, the first device within the maximum duration based at least in part on a charging rule; and refraining from charging the first device after the maximum duration.

Aspect 5: The method of Aspect 4, further comprising: receiving, from the first device, another request for energy after the maximum duration; and charging the second device based at least in part on the charging rule.

Aspect 6: A method of wireless communication performed by a first device, comprising: generating historical information that is associated with a timing for the first device between requesting and receiving energy in association with energy harvesting: generating a request for energy from a second device that is capable of charging the first device in association with energy harvesting; and transmitting, to the second device, the request and the historical information.

Aspect 7: The method of Aspect 6, wherein the historical information includes an average duration for the first device between requesting and receiving energy.

Aspect 8: The method of Aspect 7, further comprising calculating the average duration for the first device based at least in part on a specified quantity of most recent requests.

Aspect 9: The method of any of Aspects 6-8, wherein the historical information includes a longest duration for the first device between requesting and receiving energy.

Aspect 10: The method of any of Aspects 6-9, wherein the historical information includes a most recent time when the first device received energy upon request.

Aspect 11: The method of any of Aspects 6-10, wherein the historical information includes a median duration for the first device between requesting and receiving energy.

Aspect 12: A method of wireless communication performed by a second device, comprising: receiving, from a first device, a request for energy from the second device; and performing one of charging the first device, refraining from charging the first device, or charging a third device based at least in part on historical information that is associated with a timing for the first device between requesting and receiving energy.

Aspect 13: The method of Aspect 12, further comprising receiving the historical information from the first device.

Aspect 14: The method of Aspect 12 or 13, wherein the historical information includes an average duration for the first device between requesting and receiving energy.

Aspect 15: The method of Aspect 14, wherein the performing includes charging the first device if the average duration for the first device is greater than an average duration for the third device, or charging the third device if the average duration for the third device is greater than the average duration for the first device.

Aspect 16: The method of any of Aspects 12-15, wherein the historical information includes a longest duration for the first device between requesting and receiving energy.

Aspect 17: The method of any of Aspects 12-16, wherein the historical information includes a most recent time when the first device received energy upon request.

Aspect 18: The method of any of Aspects 12-17, wherein the historical information includes a median duration for the first device between requesting and receiving energy.

Aspect 19: An apparatus for wireless communication at a device, comprising a processor: memory coupled with the processor; and instructions stored in the memory and executable by the processor to cause the apparatus to perform the method of one or more of Aspects 1-18.

Aspect 20: A device for wireless communication, comprising a memory and one or more processors coupled to the memory, the one or more processors configured to perform the method of one or more of Aspects 1-18.

Aspect 21: An apparatus for wireless communication, comprising at least one means for performing the method of one or more of Aspects 1-18.

Aspect 22: A non-transitory computer-readable medium storing code for wireless communication, the code comprising instructions executable by a processor to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first device for wireless communication, comprising:
a memory; and
one or more processors, coupled to the memory, configured to:
generate a request for energy from a second device that is capable of charging the first device in association with energy harvesting;
generate an indication that indicates a maximum duration for which the request applies; and
transmit the request and the indication to the second device.

2. The first device of claim 1, wherein the one or more processors, to transmit the indication, are configured to transmit the indication in assistance information.

3. The first device of claim 1, wherein the one or more processors are configured to, if energy is not received during the maximum duration:
transmit another request for energy to the second device: or
select another energy source.

4. A second device for wireless communication, comprising:
a memory; and
one or more processors, coupled to the memory, configured to:
receive, from a first device, a request for energy from the second device and an indication that indicates a maximum duration for which the request applies;
charge, in association with energy harvesting, the first device within the maximum duration based at least in part on a charging rule; and
refrain from charging the first device after the maximum duration.

5. The second device of claim 4, wherein the one or more processors are configured to:
receive, from the first device, another request for energy after the maximum duration; and
charge the second device based at least in part on the charging rule.

6. A first device for wireless communication, comprising:
a memory; and
one or more processors, coupled to the memory, configured to:
generate historical information that is associated with a timing for the first device between requesting and receiving energy in association with energy harvesting;
generate a request for energy from a second device that is capable of charging the first device in association with energy harvesting; and
transmit, to the second device, the request and the historical information.

7. The first device of claim 6, wherein the historical information includes an average duration for the first device between requesting and receiving energy.

8. The first device of claim 7, wherein the one or more processors are configured to calculate the average duration for the first device based at least in part on a specified quantity of most recent requests.

9. The first device of claim 6, wherein the historical information includes a longest duration for the first device between requesting and receiving energy.

10. The first device of claim 6, wherein the historical information includes a most recent time when the first device received energy upon request.

11. The first device of claim 6, wherein the historical information includes a median duration for the first device between requesting and receiving energy.

12. A second device for wireless communication, comprising:
a memory; and
one or more processors, coupled to the memory, configured to:
receive, from a first device, a request for energy from the second device; and
perform one of charging the first device, refraining from charging the first device, or charging a third device based at least in part on historical information that is associated with a timing for the first device between requesting and receiving energy.

13. The second device of claim 12, wherein the one or more processors are configured to receive the historical information from the first device.

14. The second device of claim 12, wherein the historical information includes an average duration for the first device between requesting and receiving energy.

15. The second device of claim 14, wherein the one or more processors are configured to charge the first device if the average duration for the first device is greater than an average duration for the third device, or charge the third device if the average duration for the third device is greater than the average duration for the first device.

16. The second device of claim 12, wherein the historical information includes a longest duration for the first device between requesting and receiving energy.

17. The second device of claim 12, wherein the historical information includes a most recent time when the first device received energy upon request.

18. The second device of claim 12, wherein the historical information includes a median duration for the first device between requesting and receiving energy.
